(19) United States
(12) Patent Application Publication
(10) Pub. No.: US 2024/0061451 A1
(43) Pub. Date: Feb. 22, 2024

(54) TopSink: Liquid Storage Device with Automatic Discharge in High Volume Batches

(71) Applicant: Daniel James Beirne, Rockford, MI (US)

(72) Inventor: Daniel James Beirne, Rockford, MI (US)

(21) Appl. No.: 17/821,443

(22) Filed: Aug. 22, 2022

(51) Int. Cl. G05D 9/02; B65D 8/00; B65D 6/40

(52) U.S. Cl. CPC G05D 9/02; B65D 7/045; B65D 7/40

(57) ABSTRACT

“TopSink: Liquid Storage Device with Automatic Discharge in High Volume Batches” is a liquid storage device that automatically discharges excess liquid in preset volumes. By releasing surplus liquid from below the surface, TopSink prevents air from entering the discharge line, which significantly improves the “head”—or flow force—in the line. With no air in the line, and with the liquid being released at high volumes, the discharged liquid is able to travel a further distance—even over an incline—without external inputs like electricity. This advantage is in contrast with traditional overflow designs, which merely have a standpipe that enables excess water to trickle out of the line as the level rises. This allows air into the system, causing excess water to pool in the line and travel a minimal distance, TopSink solves this problem by releasing the energy of stored water in high volume bursts, from below the liquid's surface.

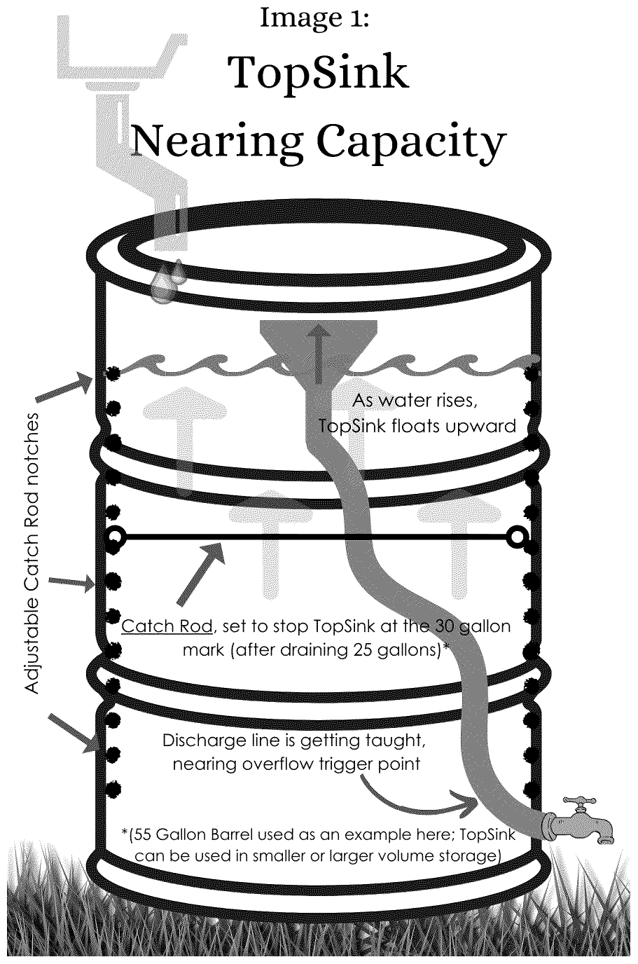

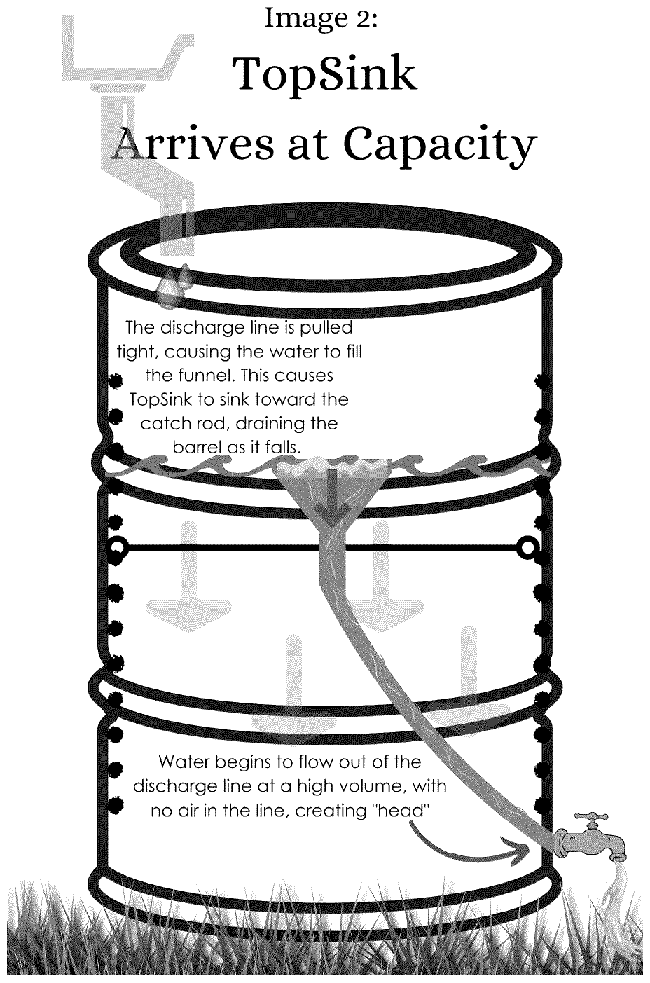

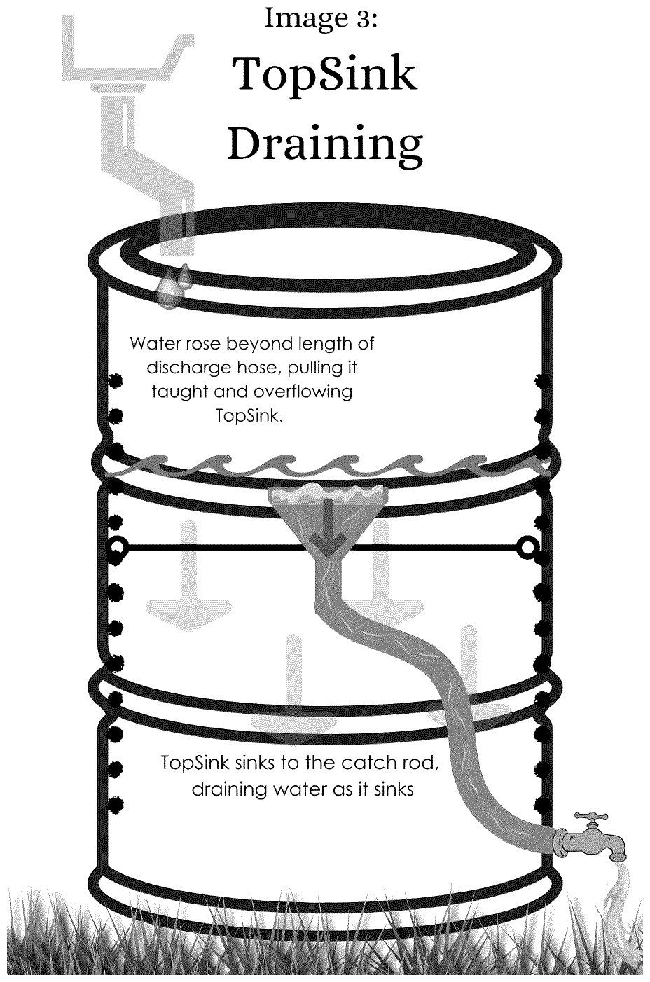

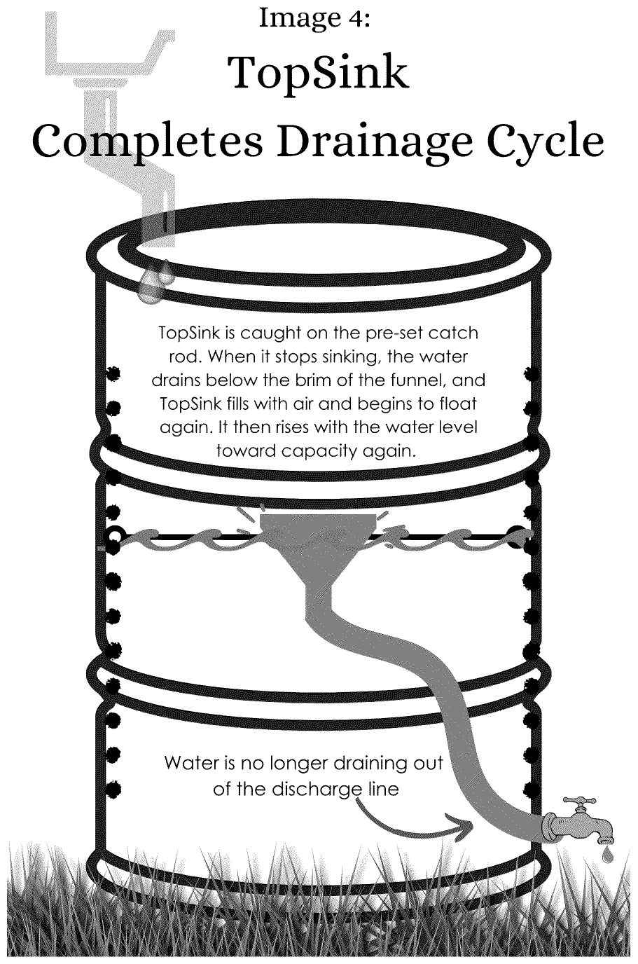

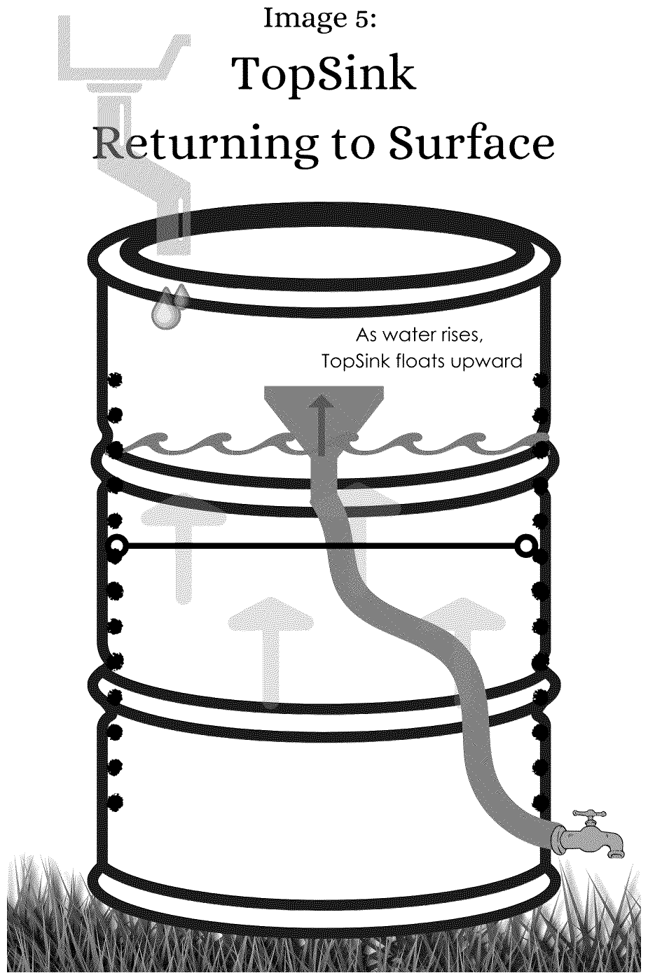

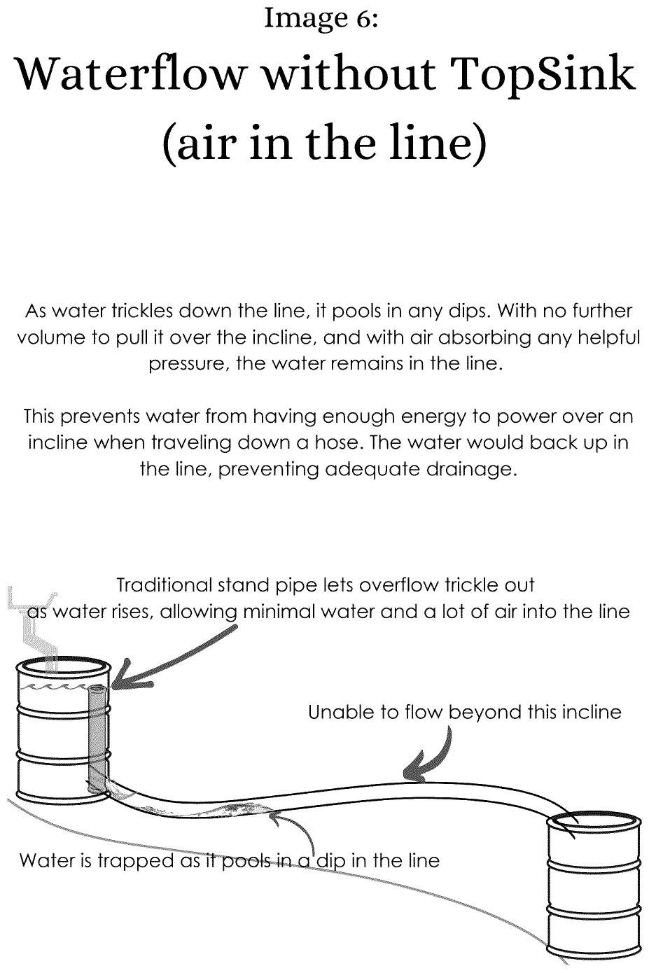

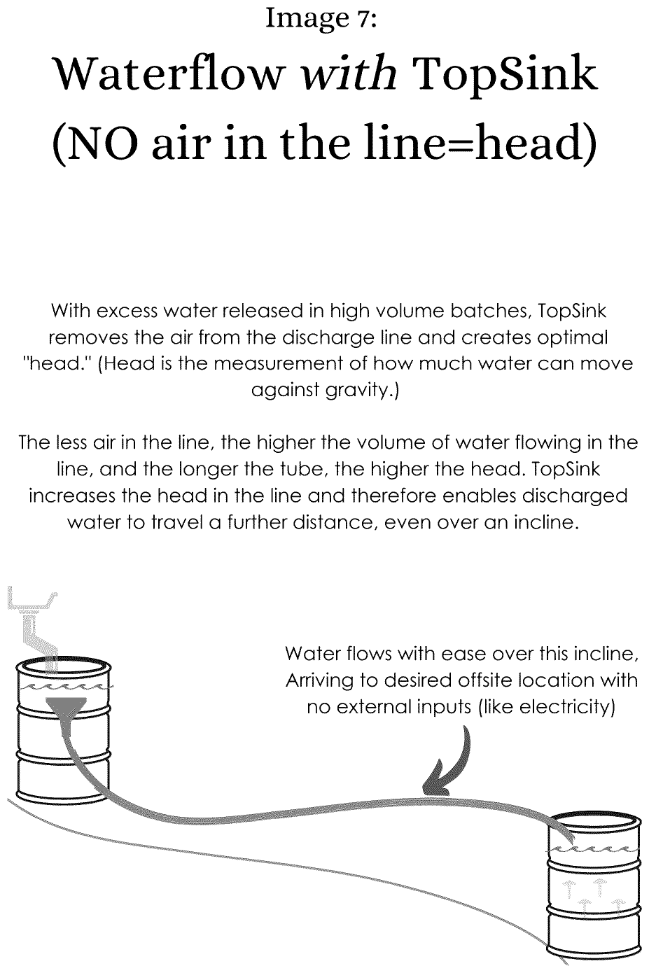

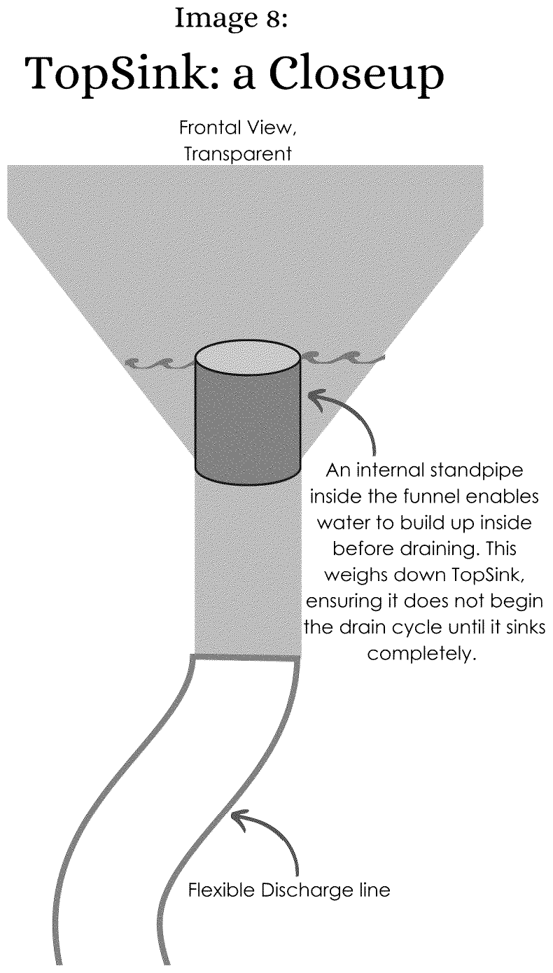

### CROSS-REFERENCE TO RELATED APPLICATIONS

Not Applicable

### STATEMENT REGARDING FEDERALLY SPONSORED RESEARCH OR DEVELOPMENT (IF APPLICABLE)

Not Applicable

### REFERENCE TO SEQUENCE LISTING, A TABLE, OR A COMPUTER PROGRAM LISTING COMPACT DISC APPENDIX (IF APPLICABLE)

Not Applicable

### BACKGROUND OF THE INVENTION

“TopSink: Liquid Storage Device with Automatic Discharge in High Volume Batches” (hereto forward referred to as “TopSink”) is useful in the area of water catchment, storage, and use. As in the case of rain barrels and watering crops or a garden, for example. It is a device that uses the energy and weight of stored water to move that same water across a distance or over an incline, with no external input. While it can be used for any liquid of the appropriate viscosity, “water” shall be used to refer to liquids in general for the remainder of this Specification.

Any amount of stored water acts like a battery; it is stored energy waiting to be used. This is why many towns pump their public water high into a tower. In the event that the power goes out, water can still flow to residents' homes through the pull of gravity. TopSink works under the same premise. This stored energy is called hydrostatic pressure. Despite this rich potential energy on even small scales, consumer options for rain water storage and collection do not include any means of harnessing this opportunity.

When the typical DIY or store-bought rain barrel design reaches capacity, its overflow—if it is equipped with one at all—is merely a stand pipe that enables surplus water to trickle out of the barrel before the barrel itself overflows. This barrel from Home Depot, for example, is one of the more popular—and more expensive—options for the consumer, and its overflow design is customary across many other rain barrel options. The trickle of water produced by the overflow in barrels like this is unusable, in terms of energy generation, because the air in the discharge line absorbs any pressure or suction that would otherwise give the flowing water force.

Herein lies the problem: These rain barrel designs wastes the potential energy of stored water, leaving the laborious moving of said water entirely up to the physical effort of the person(s) using it, or requiring the use of external inputs like electricity.

This problem presents an opportunity: if a device existed that could release a large pre-determined amount of water all at once, when capacity is reached, then the rushing flow in the discharge line would be unweakened by air and be able to carry itself further, even over an incline (as long as the final destination is lower than the point of origin).

TopSink does exactly that, TopSink is triggered when water storage reaches its full capacity, and then it releases all at once a pre-determined large volume of water, 5 gallons, 10 gallons, 20 gallons, etc, By releasing many gallons at once, instead of releasing a slow steady trickle, the large volume of water in the discharge line dramatically increases the “head” of the flow. Head is the measurement of how high water can move against gravity; it is a combination of momentum and suction in the line. The more water moving in a line, and the less air in the line, the stronger the head, With more optimal head, TopSink turns an otherwise useless trickle of excess water into a force that can surge up an incline or power a hydraulic ram pump (which uses head to pump water uphill).

On its own, without the aid of a pump, TopSink can move water across a distance and even up an incline if its final destination is still lower than the point of origin. If this same amount of excess water were released as a trickle, instead of a burst of higher volume, the water would pool and the air in the line would absorb any force that would have enabled it to power over a hill.

This idea was first envisioned in the spring of 2022, when I had collected an abundance of rainwater along the gutters of my home, but was unable to transport it easily across the yard to my garden or fruit trees. My options were to run a hose between barrels when there was enough water to create head in the line, or to carry 5 gallon buckets between the locations. Both of these options were labor intensive and, since I was not transferring the water during a rain storm, I would miss out on the dozens of gallons of water per barrel that were discharged through the overflow line during the storm.

“If only the barrel would release its overflow in 5 gallon batches, there would be enough head for the water to carry itself through the hose to the barrels in the garden each time the barrel reached capacity!” I thought. Then, after some experimentation, a repurposed funnel and some plumbers putty, a working model was created.

### BRIEF SUMMARY OF THE INVENTION

“TopSink: Liquid Storage Device with Automatic Discharge in High Volume Batches” is an automatic drainage device that floats on the surface of the water in a rain barrel or other storage device. It rises with the level of the water until it nears the barrel's maximum capacity, when it is triggered to sink and drain out a predetermined volume of water. When the barrel is filled to capacity, TopSink's discharge line is pulled taught which causes it to be overtaken by the water, filling up and quickly sinking. As it sinks it begins to drain the barrel rapidly. TopSink continues to sink and drain until it is caught by the catch rods, which are set to an adjustable, predetermined depth. The catch rods establish how much water is drained from the barrel each time capacity is reached. Water continues to drain from TopSink until the water level gets to the level of the catch rods. Then, TopSink begins to float again on the surface of the water, until capacity is reached again. By releasing a large volume of water all at once, the overflow has more power in the discharge line, enabling water to travel to a desired location without the need for external inputs like electricity.

### BRIEF DESCRIPTION OF THE SEVERAL VIEWS OF THE DRAWING

Image 1: TopSink Nearing Capacity
TopSink's discharge line is nearly taught, as the water in the barrel reaches capacity

Image 2: TopSink Arrives at Capacity
As the barrel reaches is maximum capacity, TopSink's discharge line is pulled tight, causing the funnel to be overflowed with water. It begins to sink, and the drainage cycle has begun.

Image 3: TopSink Draining
TopSink is now sinking, draining water as it drifts toward the catch rods which are at a preset depth. This establishes how much water is discharged each time the barrel reaches capacity.

Image 4: TopSink Completes Drainage Cycle
TopSink rests on the catch rods and, no longer sinking, completes its drain cycle from the newly established depth

Image 5: TopSink Returning to Surface
Floating again, with no water in the line, TopSink now rises with the water toward capacity once again

Image 6: Water flow without TopSink—air in the line
In this drawing, it can be seen how air in a discharge line prevents water from flowing with any force

Image 7: Water flow with TopSink—no air in the line
In this drawing, it can be seen how increased head in the line (minimal air and maximal water) amplifies the force of the water, even over an incline

Image: TopSink: a close up
This transparent view of the funnel portion of TopSink reveals the internal standpipe, which allows water to build up and weigh down the funnel before sinking and starting the drainage cycle.

### DETAILED DESCRIPTION OF THE INVENTION

In the simplest terms, “TopSink: Liquid Storage Device with Automatic Discharge in High Volume Batches” is a floating, modified, funnel attached to a flexible discharge line on the inside of a rain barrel.

From top to bottom, TopSink consists of a floating, modified funnel inside any type of water storage. The funnel is connected to a flexible discharge line which connects to a port on the side of the barrel. Just outside the barrel, this port has a shut off which can be used to turn TopSink's drainage cycles on or off. This shut off is connected to a hose that runs to the desired destination for the water, like another barrel or a reservoir away from the house.

The modified funnel floats when the water in the barrel is below capacity because the funnel and the discharge line are filled with air so they float like an empty bottle.

When the water in the storage container approaches capacity. TopSink's discharge line is pulled taught, anchoring the brim of TopSink as the water continues to rise. The water eventually overtakes TopSink and the funnel quickly fills with water and sinks. There is a short standpipe inside the funnel, which enables water to build up in the funnel before it begins to drain. This gives the funnel added weight before it sinks and begins to drain, which makes for a quicker trigger point once capacity is reached.

When TopSink sinks, water quickly begins to flow out of it through the discharge line. Since the line is submerged now, no air enters the system, creating optimal “head” in the discharge line. This is TopSink's primary function and advantage, and where it is differentiated from more traditional overflow designs; it drains water from below the surface, at a high volume, creating a strong flowing force in the discharge line.

TopSink sinks from the surface all the way down to a preset catch rod. The catch rod can be set to stop TopSink after discharging 3 gallons, 10 gallons, 13 the way up to 30 gallons of release. These measurements can change relative to the size of the container.

From the catch rod, TopSink continues to drain the barrel until the water level falls just below TopSink's new location. Then, the brim of the funnel begins to rise above the surface of the water, and as the last of the drained water gurgles out of the funnel and discharge line, TopSink begins to float on the surface of the water as it rises again. No water is flowing out of the discharge line at this time because its opening is above the surface of the rising water.

Whether the water level continues to rise from the current rain storm, or the next one weeks later, TopSink will stay afloat on the surface until it reaches capacity again, when the cycle will begin again.

TopSink provides the following advantages;
1. TopSink's primary advantage, as discussed, is that it drains water from beneath the surface, at a high volume, creating head in the discharge line. This can be used to power the water over an incline, across a distance, or to power a hydraulic ram pump. It enables water to automatically be moved between two locations, with topography in between,
2. Because TopSink releases the excess water from the upper portion of the storage device, it skims off any surface scum, algae, or mosquito larvae that may have developed on the water when it was still. In doing so, TopSink drastically reduces the amount of harmful algae, mosquitoes or pests that can be associated with long term water storage. This can be a particularly advantageous detail in settings where algae and mosquitoes carry disease in water supplies.
3. TopSink releases the excess water from the top portion of the barrel, as opposed to the bottom. This increases the buoyancy level of the discharged water, adding several more feet of height to the final destination to which the water may flow. In other words, the water is released from a higher height than if it were merely released from the bottom of the barrel, which translates into potential flow over that many more feet of incline. If TopSink is set to release 5 gallons of water each time the barrel reaches capacity, for example, this means it releases that water from the 50 gallon mark—very near the top of the barrel. In a typical 55 gallon barrel, that is more than 3 feet higher than the bottom of the barrel. This means that the discharged water may now reach a destination that is up to 3 feet higher than if it were released from the bottom of the barrel.

1. A liquid storage device comprising:
a sealed liquid storage container;
a funnel with an internal standpipe inside of said liquid storage container;
a flexible discharge line connected to the base of said funnel;
a shut off valve on the exterior of said liquid storage container, connected to the end of said flexible discharge line;
an adjustable rod upon which said funnel may rest.

2. A liquid storage device as in claim 1, further comprising:
intermittent indentations at varying depths inside said water storage container, wherein said adjustable rod attaches to the inside of said water storage container at a desired depth.

3. A liquid storage device as in claim 1, wherein the length of said flexible discharge line extends to the height of the maximum capacity of said water storage device, and no further.
